(19) United States
(12) Patent Application Publication
(10) Pub. No.: US 2023/0286291 A1
(43) Pub. Date: Sep. 14, 2023

(54) THREE-DIMENSIONAL OBJECT PRINTING DEVICE AND CONTROL DEVICE

(71) Applicant: SEIKO EPSON CORPORATION, Tokyo (JP)

(72) Inventor: Masaru KUMAGAI, Shiojiri-Shi (JP)

(21) Appl. No.: 18/180,735

(22) Filed: Mar. 8, 2023

(30) Foreign Application Priority Data
Mar. 9, 2022 (JP) 2022-035992

(51) Int. Cl. B41J 3/407; B25J 11/00; B41M 7/00; B41J 29/393; B25J 9/16

(52) U.S. Cl. CPC B41J 3/4073; B25J 11/0075; B41M 7/0081; B41J 29/393; B25J 9/1615; B25J 17/00

(57) ABSTRACT

A three-dimensional object printing device includes a head that ejects a liquid onto a three-dimensional workpiece and a robot that changes the position of the head relative to the three-dimensional workpiece. The robot has N number of joints that are pivotable about a plurality of pivot axes that differ from each other where N is a natural number of two or more. The three-dimensional object printing device executes a first print operation in which the head ejects the liquid to a first region on the workpiece while the robot changes the position of the head relative to the workpiece, the number of joints that pivot during the first print operation among the N number of joints is M (1≤M≤N), and at least one joint of the M number of joints does not pivot backward during the first print operation.

The present application is based on, and claims priority from JP Application Serial Number 2022-035992, filed Mar. 9, 2022, the disclosure of which is hereby incorporated by reference herein in its entirety.

### BACKGROUND

### 1. Technical Field

The present disclosure relates to a three-dimensional object printing device and a control device.

### 2. Related Art

A three-dimensional object printing device that performs printing on the surface of a three-dimensional workpiece by using an ink jet system is known. For example, the printer described in JP-A-2016-215438 includes an ink jet head, a 6-axis vertical jointed-arm robot that holds the ink jet head, and a control device that controls the driving of these components.

JP-A-2016-215438 does not specifically describe how the motion route of the robot at the time of printing is determined. In the related art, image quality may be degraded due to vibration caused by the motion of the robot. Under the circumstances described above, degradation in the image quality may be suppressed when the robot is used.

### SUMMARY

To solve the problem described above, according to an aspect of the present disclosure, there is provided a three-dimensional object printing device including: a head that ejects a liquid onto a three-dimensional workpiece; and a robot that changes a position of the head relative to the three-dimensional workpiece, in which the robot has N number of joints pivotable about a plurality of pivot axes that differ from each other, N being a natural number of two or more, a first print operation in which the head ejects the liquid to a first region on the workpiece while the robot changes the position of the head relative to the workpiece is executed, the number of joints that pivot during the first print operation among the N number of joints is M, M being not less than 1 and not more than N, and at least one joint among the N number of joints does not pivot backward during the first print operation.

According to an aspect of the present disclosure, there is provided a three-dimensional object printing device including: a head that ejects a liquid onto a three-dimensional workpiece; and a robot that changes a position of the head relative to the three-dimensional workpiece, in which the robot has N number of joints pivotable about a plurality of pivot axes that differ from each other, N being a natural number of two or more, a print operation in which the head ejects the liquid onto the workpiece while the robot changes the position of the head relative to the workpiece is executed, the number of joints that pivot during the print operation is N, and the N number of joints do not pivot backward during the print operation.

According to an aspect of the present disclosure, there is provided a control device that controls driving of a robot that changes a position of a head ejecting a liquid onto a three-dimensional workpiece, in which the robot includes a plurality of joints pivotable about a plurality of pivot axes that differ from each other, when at least one joint among the plurality of joints pivots backward along a motion route of the robot while the head ejects the liquid onto the workpiece, information about backward pivot is reported to a user in advance.

### BRIEF DESCRIPTION OF THE DRAWINGS

FIG. 1 is a perspective view schematically illustrating a three-dimensional object printing device according to an embodiment.

FIG. 2 is a block diagram illustrating an electric structure of a three-dimensional object printing device according to the embodiment.

FIG. 3 is a perspective view illustrating a schematic structure of a head unit according to the embodiment.

FIG. 4 is a diagram for describing an example of the movable range of a head by a robot.

FIG. 5 is a diagram illustrating temporal changes in the motion amounts of joints when the robot operates as illustrated in FIG. 4.

FIG. 6 is a diagram for describing the motion amount when the joint pivots backward.

FIG. 7 is a diagram for describing changes in the position in a sub-scanning direction when the joint pivots backward.

FIG. 8 is a diagram for describing a first region and a second region on a workpiece.

FIG. 9 is a diagram illustrating a flow of operation of a three-dimensional object printing device according to the embodiment.

FIG. 10 is a diagram for describing the movement route of a head according to the embodiment.

### DESCRIPTION OF EXEMPLARY EMBODIMENTS

Preferred embodiments of the present disclosure will be described below with reference to the accompanying drawings. It should be noted that the dimensions and scales of individual sections in the drawings differ from actual ones as appropriate, and some portions are illustrated schematically for easy understanding. In addition, the scope of the present disclosure is not limited to these embodiments unless a description that limits the present disclosure is present in the following.

For convenience, X-, Y-, and Z-axes that intersect each other will be used as appropriate in the following description. In addition, in the following description, one direction in X-axis directions is an X1 direction, and the direction opposite to the X1 direction is an X2 direction. Similarly, Y-axis directions opposite to each other are a Y1 direction and a Y2 direction. In addition, Z-axis directions opposite to each other are a Z1 direction and a Z2 direction.

Here, the X-axis, the Y-axis, and the Z-axis correspond to the coordinate axes of the world coordinate system set in a space in which a robot 2 described later is installed. Typically, the Z-axis is a vertical axis and the Z2 direction corresponds to the vertically downward direction. The world coordinate system is associated, by calibration, with the base coordinate system that is based on the position of a base portion 210, which will be described later, of the robot 2. In the following, for convenience, the case in which the world coordinate system is used as a robot coordinate system to control the motion of the robot 2 will be exemplified.

It should be noted that the Z-axis does not need to be a vertical axis. In addition, although the X-axis, the Y-axis, and the Z-axis are typically orthogonal to each other, they do not need to be orthogonal to each other. For example, the X-axis, the Y-axis, and the Z-axis need only intersect each other at angles within the range of 80° to 100°.

### 1. Embodiments

### 1-1. Overview of a Three-Dimensional Object Printing Device

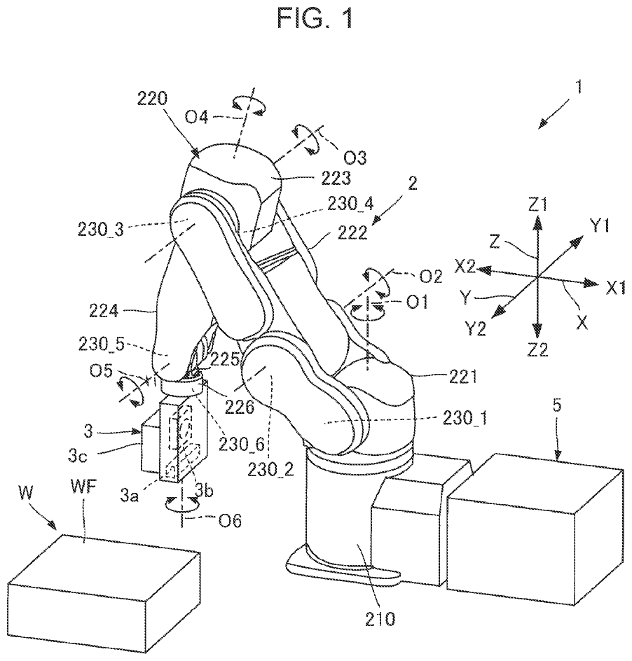

FIG. 1 is a perspective view schematically illustrating a three-dimensional object printing device 1 according to an embodiment. The three-dimensional object printing device 1 performs printing on the surface of a three-dimensional workpiece W by using an ink jet system.

The workpiece W has a surface WF as a print target. In the example illustrated in FIG. 1, the workpiece W is a rectangular parallelepiped, and a plane WF is a plane that faces the Z1 direction. It should be noted that the properties of the workpiece W, such as the shape or the size, are not limited to the example illustrated in FIG. 1 and may be any shape and size. For example, the surface WF is not limited to a plane and may include, for example, a convex or concave curved surface or a stepped surface. In addition, the installation attitude of the workpiece W is not limited to the example illustrated in FIG. 1 and may be any attitude

In the example illustrated in FIG. 1, the three-dimensional object printing device 1 is an ink jet printer that incorporates a vertical jointed-arm robot.

Specifically, as illustrated in FIG. 1, the three-dimensional object printing device 1 has the robot 2, a head unit 3, and a controller 5. First, the individual portions of the three-dimensional object printing device 1 illustrated in FIG. 1 will be briefly described below in sequence.

The robot 2 is a moving mechanism that changes the position and the attitude of the head unit 3 with respect to the workpiece W. In the example illustrated in FIG. 1, the robot 2 is a so-called 6-axis vertical jointed-arm robot. Specifically, the robot 2 includes an arm 220 having one end that supports a head 3a and a base portion 210 coupled to the other end of the arm 220.

The base portion 210 is a platform that supports the arm 220. In the example illustrated in FIG. 1, the base portion 210 is fixed to an installation surface, such as a floor facing the Z1 direction, by screws or the like. It should be noted that the installation surface to which the base portion 210 is fixed may face any direction, is not limited to the example illustrated in FIG. 1, and may be a wall, a ceiling, or a surface of a movable bogie.

The arm 220 is a 6-axis robot arm having a base end attached to the base portion 210 and a front end that changes in three-dimensional position and attitude with respect to the base end. Specifically, the arm 220 includes arms 221, 222, 223, 224, 225, and 226, also referred to as links, that are joined in this order.

The arm 221 is joined to the base portion 210 via a joint 230_1 so as to be pivotable about a pivot axis O1. The arm 222 is joined to the arm 221 via a joint 230_2 so as to be pivotable about the pivot axis O2. The arm 223 is joined to the arm 222 via a joint 230_3 so as to be pivotable about a pivot axis O3. The arm 224 is joined to the arm 223 via a joint 230_4 so as to be pivotable about a pivot axis O4. The arm 225 is joined to the arm 224 via a joint 230_5 so as to be pivotable about a pivot axis O5. The arm 226 is joined to the arm 225 via a joint 230 6 so as to be pivotable about a pivot axis O6. It should be noted that each of the joints 230_1 to 230_6 may be referred to below as a joint 230.

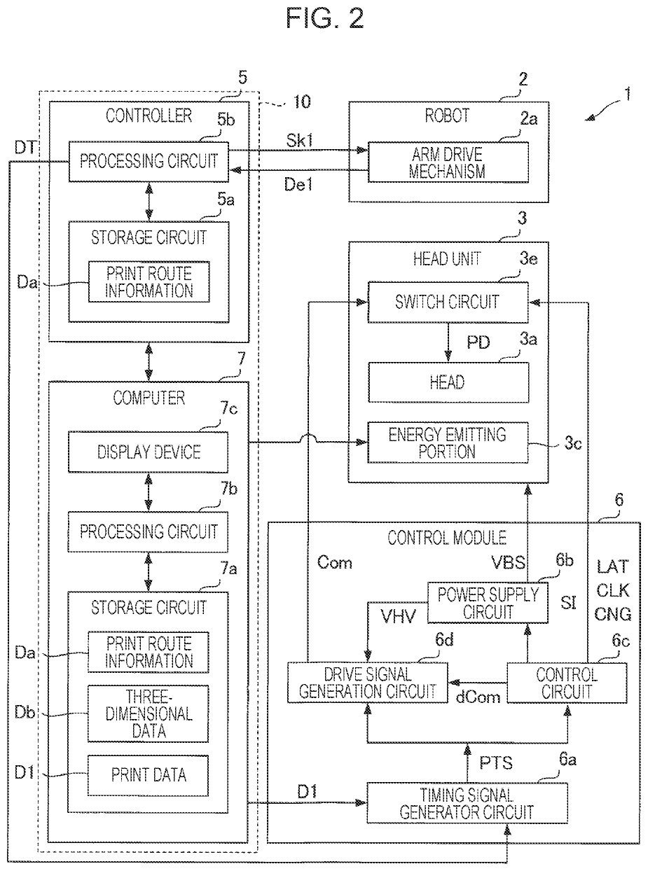

In the example illustrated in FIG. 1, the number N of joints 230 is six. Each of the joints 230_1 to 230_6 is a mechanism that pivotably joins one of two adjacent arms to the other. Although not illustrated in FIG. 1, each of the joints 230_1 to 230_6 has a drive mechanism that pivots one of the two adjacent arms with respect to the other. The drive mechanism includes, for example, a motor that generates a driving force for the pivot, a speed reducer that reduces the driving force and outputs the reduced driving force, and an encoder, such as a rotary encoder, that detects the motion amount such as the pivot angle. It should be noted that an aggregation of the drive mechanisms corresponds to an arm drive mechanism 2a illustrated in FIG. 2, which will be described later.

The pivot axes O1 to O6 differ from each other. In the example illustrated in FIG. 1, the pivot axis O1 is orthogonal to the installation surface, not illustrated, to which the base portion 210 is fixed. The pivot axis O2 is orthogonal to the pivot axis O1. The pivot axis O3 is parallel to the pivot axis O2. The pivot axis O4 is orthogonal to the pivot axis O3. The pivot axis O5 is orthogonal to the pivot axis O4. The pivot axis O6 is orthogonal to the pivot axis O5.

It should be noted that, regarding these pivot axes, “orthogonal” means that the angle formed by two pivot axes is exactly 90° and that the angle formed by two pivot axes is 90°±approximately 5°. Similarly, “parallel” means that two pivot axes are exactly parallel to each other and that one of the two pivot axes is inclined by approximately ±5° to the other.

The head unit 3 as an end effector is attached to the front end of the arm 220, that is, the arm 226.

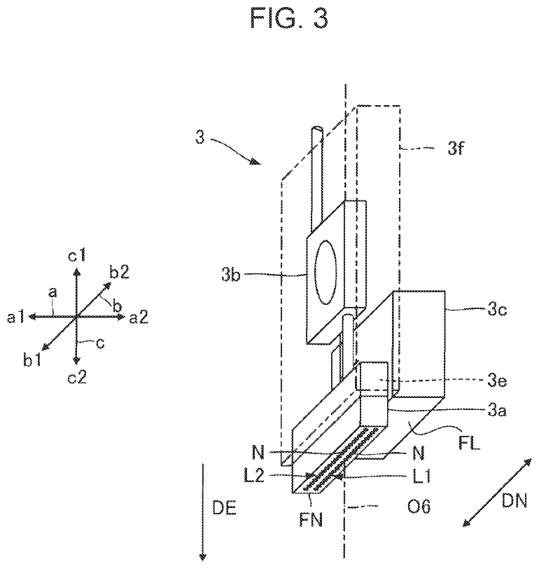

The head unit 3 is an assembly having the head 3a that ejects ink, which is an example of the liquid, onto the workpiece W. In the embodiment, the head unit 3 has a pressure regulating valve 3b and an energy emitting portion 3c in addition to the head 3a. Since both are fixed to the arm 226, the relationship of their positions and the relationship of their attitudes are fixed. It should be noted that details of the head unit 3 will be described later with reference to FIG. 3.

The ink is not particularly limited and, for example, an aqueous ink in which a coloring material such as a dye or a pigment is dissolved in an aqueous solvent, a curing ink including a curing resin such as an ultraviolet curing resin, and a solvent-based ink in which a coloring material such as a dye or a pigment is dissolved in an organic solvent. It should be noted that the ink is not limited to a solution and may be an ink in which a coloring material or the like is dispersed as a dispersoid in a dispersion medium. Furthermore, the ink is not limited to the ink containing a coloring material and may be an ink containing conductive particles such as metal particles for forming wiring or the like as a dispersoid.

The controller 5 is the robot controller that controls the driving of the robot 2. The electric structure of the three-dimensional object printing device 1 as well as details of the controller 5 will be described with reference to FIG. 2.

### 1-2. Electric Structure of the Three-Dimensional Object Printing Device

FIG. 2 is a block diagram illustrating the electric structure of the three-dimensional object printing device 1 according to the embodiment. FIG. 2 illustrates the electrical components among the components of the three-dimensional object printing device 1. As illustrated in FIG. 2, in addition to the components illustrated in FIG. 1, the three-dimensional object printing device 1 includes a control module 6 communicably coupled to the controller 5, and a computer 7 communicably coupled to the controller 5 and the control module 6.

Here, the controller 5 and the computer 7 constitute the control device 10 for controlling the driving of the robot 2. It should be noted that each of the electrical components illustrated in FIG. 2 may be divided as appropriate, may be included in another component, or may be integrated with another component. For example, part or all of the function of the controller 5 or the control module 6 may be achieved by the computer 7 or may be achieved by another external device such as a personal computer (PC) coupled to the controller 5 via a network such as a local area network (LAN) or the Internet.

The controller 5 has a function of controlling the driving of the robot 2 and a function of generating a signal DT for synchronizing the ejecting operation of the ink in the head unit 3 with the motion of the robot 2.

The controller 5 has a storage circuit 5a and a processing circuit 5b.

The storage circuit 5a stores various types of programs executed by the processing circuit 5b and various types of data processed by the processing circuit 5b. The storage circuit 5a includes, for example, one or both semiconductor memories of a volatile memory such as random access memory (RAM) and a non-volatile memory such as read-only memory (ROM), an electrically erasable and programmable read-only memory (EEPROM), or a programmable ROM (PROM). It should be noted that part or all of the storage circuit 5a may be included in the processing circuit 5b.

Print route information Da is stored in the storage circuit 5a. The print route information Da is used to control the motion of the robot 2 and indicates the position and the attitude of the head 3a in the route according to which the head 3a is moved. The print route information Da is represented by use of, for example, coordinate values in the base coordinate system or the world coordinate system. The print route information Da is generated by the computer 7 based on three-dimensional data db that represents, for example, the shape of the workpiece W. The print route information Da is input to the storage circuit 5a from the computer 7. It should be noted that the print route information Da may be represented by use of the coordinate values in the workpiece coordinate system. In this case, the print route information Da is used to control the motion of the robot 2 after being converted to the coordinate values in the base coordinate system or the world coordinate system from the coordinate values in the workpiece coordinate system.

The processing circuit 5b controls the motion of the arm drive mechanism 2a of the robot 2 based on the print route information Da and generates the signal DT. The processing circuit 5b includes, for example, one or more processors such as a central processing unit (CPU). It should be noted that the processing circuit 5b may include a programmable logic device such as a field-programmable gate array (FPGA) instead of or in addition to the CPU.

Here, the arm drive mechanism 2a is an aggregation of the drive mechanisms of the joints 230_1 to 230_6 described above and includes, for each of the joints 230, a motor for driving the joint 230 of the robot 2 and an encoder for detecting the rotation angle of the joint 230 of the robot 2.

The processing circuit 5b performs an inverse kinematics calculation, which converts the print route information Da to the motion amounts such as the rotation angles and the rotation speeds of the joints 230 of the robot 2. Then, the processing circuit 5b outputs a control signal Sk1 based on an output Del from each of the encoders of the arm drive mechanism 2a such that the motion amounts such as the actual rotation angle and the actual rotation speed of each of the joints 230 become the calculation result that is based on the print route information Da. The control signal Sk1 controls the driving of the motor of the arm drive mechanism 2a. Here, the control signal Sk1 is corrected as necessary by the processing circuit 5b based on an output from a distance sensor, which is not illustrated.

In addition, the processing circuit 5b generates the signal DT based on the output Del from at least one of the plurality of encoders of the arm drive mechanism 2a. For example, the processing circuit 5b generates, as the signal DT, a trigger signal including a pulse at a timing at which the output Del from one of the plurality of encoders becomes a predetermined value.

The control module 6 is a circuit that controls the ejecting operation of the ink by the head unit 3 based on the signal DT output from the controller 5 and the print data Dl from the computer 7. The control module 6 includes a timing signal generation circuit 6a, a power supply circuit 6b, a control circuit 6c, and a drive signal generation circuit 6d.

The timing signal generation circuit 6a generates a timing signal PTS based on the signal DT. The timing signal generation circuit 6a includes a timer that starts the generation of the timing signal PTS according to, for example, the detection of the signal DT.

The power supply circuit 6b receives electric power from a commercially available power source, which is not illustrated, and generates various predetermined electric potentials. The various generated electric potentials are supplied as appropriate to individual components of the control module 6 and the head unit 3. For example, the power supply circuit 6b generates a power supply potential VHV and an offset potential VBS. The offset potential VBS is supplied to the head unit 3. In addition, the power supply potential VHV is supplied to the drive signal generation circuit 6d.

The control circuit 6c generates a control signal SI, a waveform specification signal dCom, a latch signal LAT, a clock signal CLK, and a change signal CNG based on the timing signal PTS. These signals are synchronized with the timing signal PTS. Of these signals, the waveform specification signal dCom is input to the drive signal generation circuit 6d, and the other signals are input to a switch circuit 3e of the head unit 3.

The control signal SI is a digital signal for specifying the operating state of the drive element in the head 3a of the head unit 3. Specifically, the control signal SI specifies whether to supply the drive signal Com, which will be described later, to the drive element based on the print data Dl. This specifies, for example, whether to eject the ink from the nozzle corresponding to the drive element or specifies the amount of the ink to be ejected from the nozzle. The waveform specification signal dCom is a digital signal for specifying the waveform of the drive signal Com. The latch signal LAT and the change signal CNG are used together with the control signal SI to specify the driving timing of the drive element, thereby specifying the timing at which the ink is ejected from the nozzle. The clock signal CLK is a reference clock signal that is synchronized with the timing signal PTS.

The control circuit 6c described above includes, for example, one or more processors such as a central processing unit (CPU). It should be noted that the control circuit 6c may include a programmable logic device such as an FPGA instead of or in addition to a CPU.

The drive signal generation circuit 6d generates the drive signal Com for driving drive elements in the head 3a of the head unit 3. Specifically, the drive signal generation circuit 6d has, for example, a DA converter circuit and an amplifier circuit. In the drive signal generation circuit 6d, the DA converter circuit converts the waveform specification signal dCom, which is a digital signal, from the control circuit 6c to an analog signal, and the amplifier circuit generates the drive signal Com by amplifying the analog signal by using the power supply potential VHV from the power supply circuit 6b. Here, the signal having the waveform actually supplied to the drive element among the waveforms included in the drive signal Com is the driving pulse PD. The drive pulse PD is supplied from the drive signal generation circuit 6d to the drive element via the switch circuit 3e of the head unit 3.

Here, the switch circuit 3e includes a switching element that switches between whether or not to supply, as the driving pulse PD, at least part of the waveforms included in the drive signal Com based on the control signal SI.

The computer 7 is a desktop or notebook computer in which a program such as a program PG has been installed. The computer 7 has a function of generating the print data Dl and the print route information Da, a function of supplying information such as the print route information Da to the controller 5, and a function of supplying information such as the print data Dl to the control module 6. The computer 7 according to the embodiment has a function of controlling the driving of the energy emitting portion 3c in addition to these functions.

The computer 7 includes a storage circuit 7a, a processing circuit 7b, and a display device 7c. It should be noted that the computer 7 may have an input device that receives an operation from the user in addition to these components. The input device has a pointing device, such as a touch pad, a touch panel, or a mouse.

The display device 7c displays various images under the control of the processing circuit 7b. The display device 7c may have various types of display panels such as a liquid crystal display panel or an organic electro-luminescence (EL) display panel. It should be noted that the display device 7c may be a touch panel that also functions as an input device. The display device 7c and the input device may be provided separately from the computer 7.

The storage circuit 7a stores various types of programs executed by the processing circuit 7b and various types of data processed by the processing circuit 7b. The storage circuit 7a includes, for example, one or both semiconductor memories of a volatile memory such a RAM and a semiconductor memory that is a non-volatile memory such as a ROM, an EEPROM, or a PROM. It should be noted that part or all of the storage circuit 7a may be included in the processing circuit 7b.

The storage circuit 7a stores the print route information Da, the three-dimensional data db, and the print data Dl. The three-dimensional data db represents the three-dimensional shape of the workpiece W. The format of the three-dimensional data db is not particularly limited and is data in, for example, the Standard Triangulated Language (STL) format. The three-dimensional data db is obtained by converting CAD (computer-aided design) data as necessary. It should be noted that the three-dimensional data db may be represented by coordinate values in the workpiece coordinate system or may be represented by coordinate values in the base coordinate system or the world coordinate system.

The print data Dl is image data in a format that can be processed by the control module 6 and is obtained by processing image data in a bitmap format such as JPEG or in a vector format such as PostScript, Portable Document Format (PDF), or XML Paper Specification (XPS). This processing includes at least one of color conversion processing, density correction processing, quantization processing, distribution processing, and raster image processor (RIP) processing, which are types of image processing.

The processing circuit 7b achieves the functions described above by executing programs read from the storage circuit 7a. The processing circuit 7b includes one or more processors, such as a CPU. It should be noted that the processing circuit 7b may include a programmable logic device such as an FPGA instead of or in addition to the CPU.

The processing circuit 7b generates the print route information Da based on the three-dimensional data db and generates the print data Dl by image processing of image data. In addition, when at least one joint 230 pivots backward along the motion route of the robot 2 while the head 3a ejects the ink onto the workpiece W, the processing circuit 7b reports information about the backward pivot in advance. The information needs only pertain to the backward pivot of the joint 230 and is not limited to information about an occurrence of the backward pivot. The information may be, for example, information about a reduction in image quality or information about the likelihood of vibration occurring during printing. In addition, the report is performed, for example, by an indication being provided through the display device 7c. It should be noted that the report is not limited to an indication being provided through the display device 7c and may be performed, for example, by a voice, a warning light, or the like or may be performed by a device external to the computer 7.

### 1-3. Head Unit

FIG. 3 is a perspective view illustrating a schematic structure of the head unit 3 according to the embodiment. For convenience, the a-axis, the b-axis, and the c-axis that intersect each other are used as appropriate in the following description. In addition, in the following description, one direction in a-axis directions is an a1 direction, and the direction opposite to the a1 direction is an a2 direction. Similarly, b-axis directions opposite to each other are a b1 direction and a b2 direction. In addition, c-axis directions opposite to each other are a c1 direction and a c2 direction.

Here, the a-axis, the b-axis, and the c-axis correspond to the coordinate axes of the tool coordinate system set in the head unit 3, and the position and the attitude relative to the world coordinate system or the world coordinate system described above change depending on the motion of the robot 2. In the example illustrated in FIG. 3, the c-axis is parallel to the pivot axis O6 described above. It should be noted that the a-axis, the b-axis, and the c-axis are typically orthogonal to each other but are not limited to being orthogonal to each other as long as these axes intersect at angles within the range of, for example, 80° to 100°. It should be noted that the tool coordinate system is associated with the base coordinate system or the robot coordinate system by calibration.

The tool coordinate system is set with reference to the tool center point. Accordingly, the position and the attitude of the head 3a are defined with reference to the tool center point. For example, the tool center point may be disposed at the center of an ejection surface FN or in a space apart in an ejection direction DE of the ink from the head 3a.

As described above, the head unit 3 includes the head 3a, the pressure regulating valve 3b, and the energy emitting portion 3c. These units are supported by a support body 3f, which is indicated by the dot-dot-dash line in FIG. 3. It should be noted that the head unit 3 has one head 3a and one pressure regulating valve 3b in the example illustrated in FIG. 3, but the numbers are not limited to the example in FIG. 3 and may be two or more. In addition, the installation position of the pressure regulating valve 3b is not limited to the arm 226 and may be, for example, another arm or the like or may be a position fixed to the base portion 210.

The support body 3f is made of, for example, a metal material or the like and is a substantially rigid body. It should be noted that the support body 3f has a flat box shape in FIG. 3, but the shape of the support body 3f is not particularly limited and may be any shape.

The support body 3f is attached to the arm 226. Accordingly, the head 3a, the pressure regulating valve 3b, and the energy emitting portion 3c are collectively supported by the arm 226 via the support body 3f. Therefore, the positions of the head 3a, the pressure regulating valve 3b, and the energy emitting portion 3c relative to the arm 226 are fixed. In the example illustrated in FIG. 3, the pressure regulating valve 3b is disposed at a position in the c1 direction with respect to the head 3a. The energy emitting portion 3c is disposed at a position in the a2 direction with respect to the head 3a.

The head 3a includes the ejection surface FN and a plurality of nozzles N that are open in the ejection surface FN. The ejection surface FN is the nozzle surface in which the nozzles N are open and is formed by a surface of a nozzle plate in which the nozzles N are provided as through-holes in a plate-like member made of a material such as silicon (Si) or metal. In the example illustrated in FIG. 3, the normal direction of the ejection surface FN, that is, the ejection direction DE of the ink from the nozzles N is the c2 direction, and the plurality of nozzles N are divided into a nozzle column L1 and a nozzle column L2 spaced apart from each other in the direction of the a-axis. Each of the nozzle column L1 and the nozzle column L2 is a set of a plurality of nozzles N disposed linearly in the direction of the b-axis. Here, the elements corresponding to the nozzles N in the nozzle column L1 and the elements corresponding to the nozzles N in the nozzle column L2 of the head 3a are substantially symmetrical with each other in a direction of the a-axis. In addition, an arrangement direction DN, which will be described later, is parallel to the b-axis.

However, the positions along the b-axis of the plurality of nozzles N in the nozzle column L1 may be identical to or different from the positions along the b-axis of the plurality of nozzles N in the nozzle column L2. In addition, the elements corresponding to the nozzles N in one of the nozzle column L1 and the nozzle column L2 may be omitted or three or more nozzle columns may be present. The structure in which the positions along the b-axis of the plurality of nozzles N in the nozzle column L1 are identical to the positions along the b-axis of the plurality of nozzles N in the nozzle column L2 is exemplified.

Although not illustrated, the head 3a has, for each of the nozzles N, a piezoelectric element which is a drive element and a cavity in which the ink is stored. Here, the piezoelectric element causes the nozzle corresponding to the cavity to eject the ink in the ejection direction DE by changing the pressure of the cavity corresponding to the piezoelectric element. The head 3a as described above can be obtained by bonding a plurality of substrates such as silicon substrates processed as appropriate by, for example, etching with an adhesive or the like. It should be noted that a heater for heating the ink in the cavity may be used instead of the piezoelectric element as the drive element for ejecting the ink from the nozzle.

The ink is supplied from the ink tank, which is not illustrated, to the head 3a via the pressure regulating valve 3b.

The pressure regulating valve 3b is a valve mechanism that opens and closes based on the pressure of the ink in the head 3a. Due to the opening and closing, even when the positional relationship between the head 3a and the ink tank, which is not illustrated, changes, the pressure of the ink in the head 3a remains a negative value within a predetermined range. Therefore, the meniscus of the ink formed in the nozzles N of the head 3a is stabilized. As a result, it is possible to prevent air bubbles from entering the nozzles N and the ink from overflowing from the nozzles N. In addition, the ink from the pressure regulating valve 3b is distributed to a plurality of portions of the head 3a as appropriate via branch channels, which are not illustrated. The ink from the ink tank, which is not illustrated, is supplied by a pump or the like to the pressure regulating valve 3b at a predetermined pressure.

The energy emitting portion 3c has an emitting surface FL from which energy such as light, heat, electron rays, or radial rays for curing or solidifying the ink on the workpiece W. For example, when the ink has ultraviolet curing properties, the energy emitting portion 3c includes a light-emitting element such as a light-emitting diode (LED) that emits ultraviolet rays. In addition, the energy emitting portion 3c may have, as appropriate, optical components, such as lenses for adjusting, for example, the emission direction and the emission range of energy.

It should be noted that the energy emitting portion 3c does not need to completely cure or completely solidify the ink on the workpiece W. In this case, for example, the energy from a curing light source separately installed on the installation surface of the base portion 210 of the robot 2 may be used to completely cure or completely solidify the ink having been irradiated with the energy from the energy emitting portion 3c.

### 1-4. Backward Pivot of a Joint

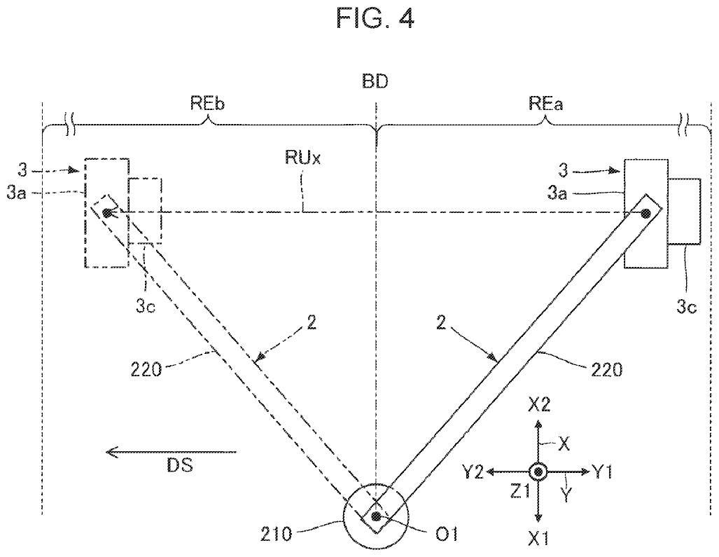

FIG. 4 is a diagram for describing an example of the movable range of the head 3a due to the motion of the robot 2. FIG. 4 illustrates the states of the robot 2 and the head unit 3 when the head 3a moves in the Y2 direction in the region in the X2 direction with respect to the base portion 210. In addition, in FIG. 4, the robot 2 and the head unit 3 at the start of movement of the head 3a are indicated by solid lines, and the robot 2 and the head unit 3 at the end of movement of the head 3a are indicated by dot-dot-dash lines. It should be noted that FIG. 4 schematically illustrates the robot 2 for convenience of explanation.

Here, the head 3a is located in a region REa at the start of movement and is located in a region REb at the end of movement. The region REa and the region REb are formed by dividing, by a boundary BD, the region in which the robot 2 can move the head 3a. The boundary BD is a virtual plane, orthogonal to the Y-axis, that passes through the base portion 210.

When the robot 2 moves the head 3a from the inside of the region REa to the inside of the region REb in the direction Y2, which is the scanning direction DS, then vibration due to the backward pivot of the joint 230 occurs at or near a timing at which the head 3a crosses the boundary BD. This point will be described below.

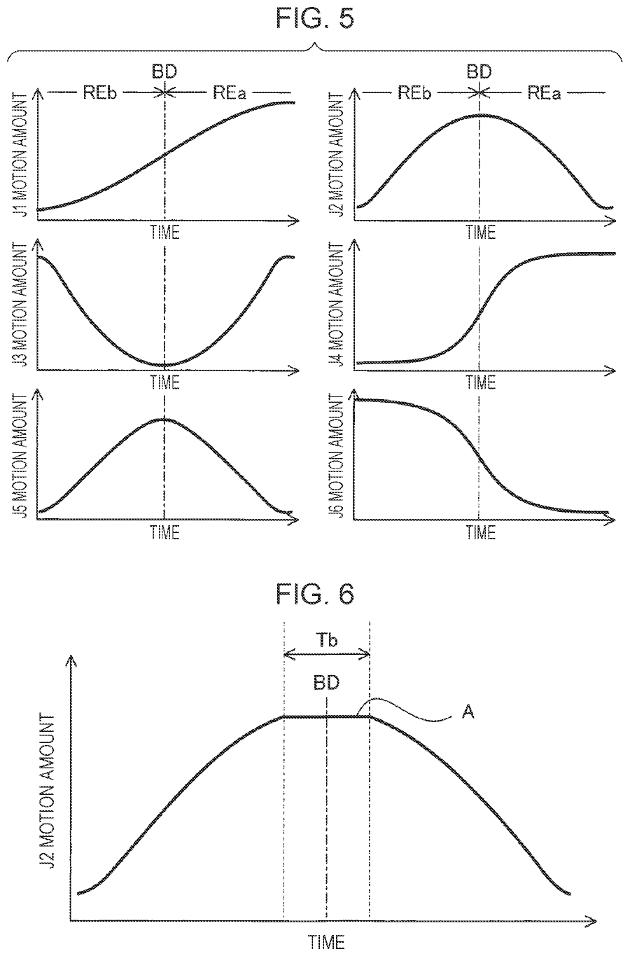

FIG. 5 is a diagram illustrating temporal changes in the motion amounts of joints 230 when the robot 2 operates as illustrated in FIG. 4. In FIG. 5, J1 MOTION AMOUNT indicates the amount of pivot of the joint 230_1 in a specific pivot direction. Similarly, in FIG. 5, J2 MOTION AMOUNT, J3 MOTION AMOUNT, J4 MOTION AMOUNT, J5 MOTION AMOUNT, and J6 MOTION AMOUNT indicate the amounts of pivot of the joint 230_2, the joint 230_3, the joint 230_4, the joint 230_5, and the joint 230_6, respectively, in specific pivot directions.

When the robot 2 operates as illustrated in FIG. 4, all of the joints 230_1 to 230_6 operate as illustrated in FIG. 5. Here, the motion amounts of the joints 230_1, 230_4, and 230_6 monotonically increase or decrease. That is, the joints 230_1, 230_4, and 230_6 pivot only in one direction and do not pivot backward even when the head 3a crosses the boundary BD. On the other hand, the motion amounts of the joints 230_2, 230_3, and 230_5 increase and then decrease, or decrease and then increase. Here, the joints 230_2, 230_3, and 230_5 pivot backward at the timing at which the head 3a crosses the boundary BD.

FIG. 6 is a diagram for describing the motion amount when the joint 230 pivots backward. In FIG. 6, the motion amount when the joint 230_2 pivots backward is exaggerated in temporal changes in the motion amount of the joint 230_2.

Although the time required for backward rotation of the motor for driving joint 230_2 should be ideally zero, the motor is forced to momentarily stop. Therefore, the motor for driving the joint 230_2 temporarily stops within a minute predetermined period Tb including the timing at which the joint 230_2 pivots backward. Accordingly, as illustrated in FIG. 6, the motion amount of the joint 230_2 does not change within the period Tb. Similarly, the motion amounts of the joints 230_3 and 230_5 do not change within periods almost the same as the period Tb.

On the other hand, since the joints 230_1, 230_4, and 230_6 do not pivot backward even within the period Tb as described above, the motion amounts change. As a result, it is difficult to move the head 3a along an ideal route. As a result, the deviation of the actual movement route of the head 3a from the ideal movement route within the period Tb becomes larger.

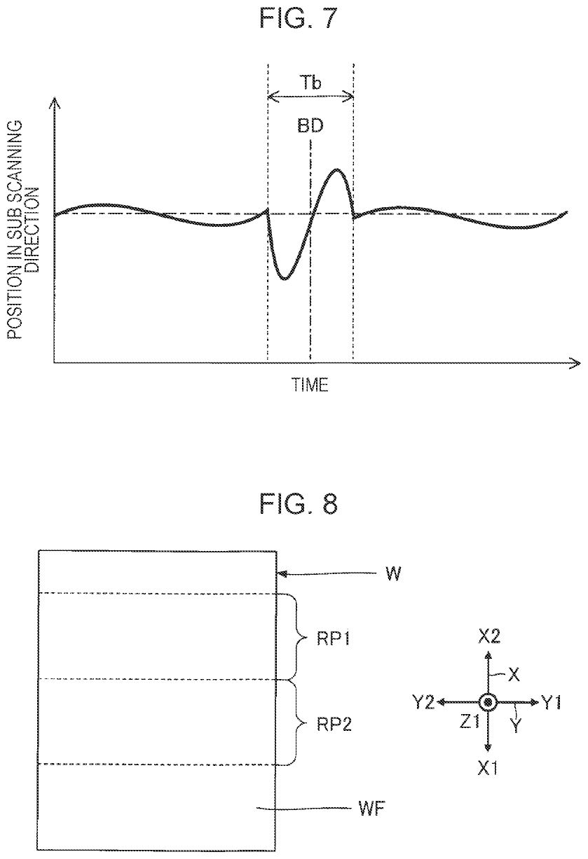

FIG. 7 is a diagram for describing changes in the position in a sub-scanning direction when the joint 230 pivots backward. In FIG. 7, the actual movement route of the head 3a is exaggerated by a solid line, and the ideal movement route of the head 3a is indicated by a dot-dash line. It should be noted that the sub-scanning direction is a direction on the workpiece W orthogonal to the scanning direction DS and is, for example, a direction of the X-axis in FIG. 4.

When the robot 2 operates as illustrated in FIG. 4, the deviation of the actual movement route of the head 3a from the ideal movement route within the period Tb becomes larger as illustrated in FIG. 7. As described above, the deviation is caused by a momentary stop of the motor for driving the joint 230_2 within the period Tb, vibration due to backward rotation of the motor, a backlash of the gear of the drive mechanism for the joint 230_2, and the like.

Therefore, the three-dimensional object printing device 1 performs printing by moving the head 3a in the direction of the Y-axis in the region REa or the region REb. However, the three-dimensional object printing device 1 may move the head 3a in a region straddling the region REa and the region REb and, in this case, information about the backward pivot of at least one of the joints 230 is reported to the user in advance through the display device 7c or the like.

### 1-5. Operation of the Three-Dimensional Object Printing Device

FIG. 8 is a diagram for describing the first region RP1 and the second region RP2 on the workpiece W. The first region RP1 and the second region RP2 are print target regions on the workpiece W. Here, the second region RP2 is a region on the workpiece W that is adjacent to the first region RP1 in the direction intersecting the scanning direction DS. In the example illustrated in FIG. 8, each of the first region RP1 and the second region RP2 extends in a direction of the Y-axis so as to have a constant width. In addition, the first region RP1 is located in the X2 direction with respect to the second region RP2. It should be noted that the first region RP1 and the second region RP2 may partially overlap each other.

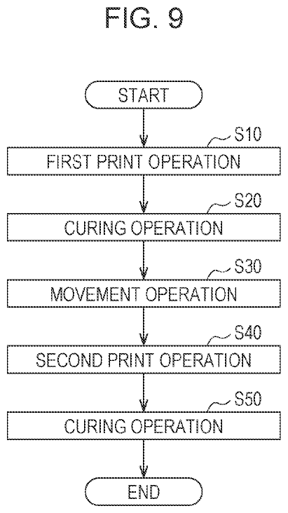

FIG. 9 is a diagram illustrating a flow of operation of the three-dimensional object printing device 1 according to the embodiment. As illustrated in FIG. 4, the three-dimensional object printing device 1 executes a first print operation S10, a curing operation S20, a movement operation S30, a second print operation S40, and a curing operation S50 in this order. Here, each of the first print operation S10 and the second print operation S40 is an example of the print operation.

In the first print operation S10, the head 3a ejects ink to the first region RP1 on the workpiece W while the robot 2 changes the position of the head 3a relative to the workpiece W. Here, the energy emitting portion 3c may irradiate the ink on the workpiece W with energy during the first print operation S10. This can cure and solidify the ink early after the ink is deposited on the workpiece W.

In the curing operation S20, the energy emitting portion 3c irradiates the ink in the first region RP1 on the workpiece W with energy and the head 3a does not emit the ink toward the workpiece W.

In the movement operation S30, the head 3a does not eject the ink onto the workpiece W while the robot 2 relatively moves the head 3a with respect to the workpiece W in the direction intersecting the scanning direction DS.

In the second print operation S40, the head 3a ejects the ink to the second region RP2 while the robot 2 causes the head 3a to relatively scan the workpiece W. Here, the energy emitting portion 3c may irradiate the ink on the workpiece W with energy during the second print operation S40. This can cure and solidify the ink on the workpiece W early after the ink is deposited on the workpiece W.

In the curing operation S50, the energy emitting portion 3c irradiates the ink in the second region PR2 on the workpiece W with energy and the head 3a does not eject the ink onto the workpiece W.

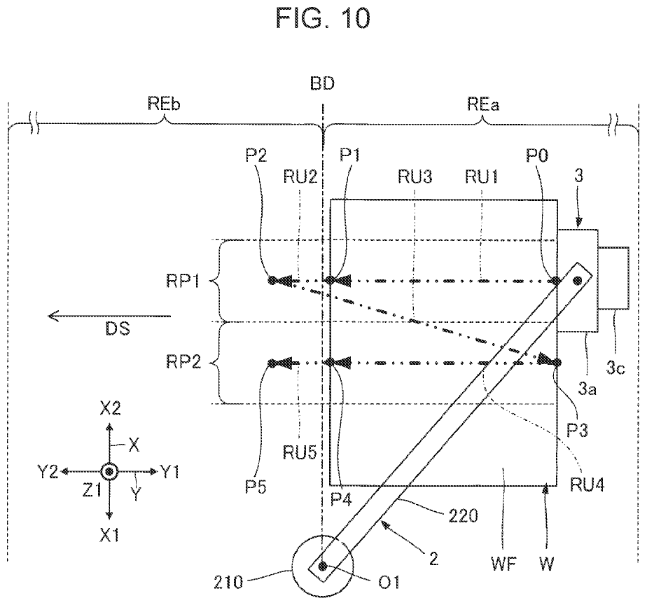

FIG. 10 is a diagram for describing the movement route of the head 3a according to the embodiment. FIG. 10 exemplifies a case in which printing is performed in the first region RP1 and the second region RP2 in this order on the workpiece W disposed in the region REa.

In the first print operation S10, the robot 2 moves the head 3a along a route RU1 from a position P0 to a position P1 in the Y2 direction. Here, when the number of joints 230 that pivot during the first print operation S10 of the N number of joints 230 is M (1≤M≤N), M=6 is met in the embodiment as described above. It should be noted that the first print operation S10 can also be represented as a first print path. Note that the number of joints 230 that rotate during execution of the printing operation may be less than six. However, from the viewpoint of causing the head 3a to properly follow the workpiece W, it is preferable that M being not less than 3.

In addition, the positions P0 and P1 and the route RU1 are located in the region REa. Accordingly, in the embodiment, none of the M number of joints 230 pivot backward during the first print operation S10 as described above. In this case, M=N is met. That is, the number of joints 230 that pivot during the print operation is N, and the N number of joints 230 do not pivot backward during the print operation. That is, all the joints 230 of the robot 2 pivot during the print operation, and none of the joints 230 pivot backward during the print operation.

In the curing operation S20, the robot 2 moves the head 3a along the route RU2 from the position P1 to a position P2 in the Y2 direction. In the curing operation S20, the ink deposited on the workpiece W at the end of the first print operation S10 can be cured or solidified.

Here, the position P1 is located in the region REa, while the position P2 is located in the region REb. That is, the head 3a moves across the boundary BD. Accordingly, at least one joint 230 of the joints 230 that do not pivot backward during the first print operation S10 pivots backward during the curing operation S20.

In the movement operation S30, the robot 2 moves the head 3a along the route RU3 from the position P2 to a position P3.

Here, the position P2 is located in the region REb, while the position P3 is located in the region REa. Moreover, the position P3 is located in the X1 direction with respect to the position P0. Accordingly, at least one joint 230 of the M number joints 230 pivots backward during the movement operation S30.

In the second movement operation S40, the robot 2 moves the head 3a along the route RU4 from the position P3 to a position P4 in the Y2 direction. Here, all the joints 230 pivot during the second print operation S40. It should be noted that the second print operation S40 can also be represented as a second print path.

In addition, the positions P3 and P4 and the route RU4 are located in the region REa. Accordingly, in the embodiment, none of the six joints 230 pivot backward during the second print operation S40 as described above.

In the curing operation S50, the robot 2 moves the head 3a along the route RU5 from the position P4 to a position P5 in the Y2 direction. In the curing operation S50, the ink deposited on the workpiece W at the end of the second print operation S40 can be cured or solidified.

Here, the position P4 is located in the region REa, while the position P5 is located in the region REb. That is, the head 3a moves across the boundary BD. Accordingly, at least one joint 230 of the joints 230 that do not pivot backward during the second print operation S40 pivots backward during the curing operation S50.

As described above, the three-dimensional object printing device 1 includes the head 3a that ejects the ink, which is an example of the liquid, onto the three-dimensional workpiece W and the robot 2 that changes the position of the head 3a relative to the workpiece W. The robot 2 has N number of joints 230 that can pivot about pivot axes that differ from each other, where N is a natural number of two or more.

As described above, the three-dimensional object printing device 1 executes the first print operation S10, which is an example of the print operation. In the first print operation S10, the head 3a ejects the ink to the first region RP1 on the workpiece W while the robot 2 changes the position of the head 3a relative to the workpiece W. Here, the N number of joints 230 that pivot during the first print operation S10 among the N number of joints 230 is M (1≤M≤N). In addition, at least one joint 230 of the M number of joints 230 does not pivot backward during the first print operation S10.

In the three-dimensional object printing device 1 as described above, since at least one joint 230 of the M number of joints 230 does not pivot backward during the first print operation S10, vibration of the head 3a during the first print operation S10 can be reduced compared with the structure in which all the M number of joints 230 pivot backward during the first print operation S10. As a result, the image quality can be improved.

In addition, as described above, the robot 2 includes the arm 220 having one end that supports the head 3a and the base portion 210 coupled to the other end of the arm 220. In addition, the N number of joints 230 include the joint 230_1, which is an example of a first joint, as a joint 230 capable of pivot the arm 220 with respect to the base portion 210. Moreover, the M number of joints 230 include the joint 230_1, and the joint 230_1 does not pivot backward during the first print operation S10.

Since the joint 230_1 is the joint 230 located farthest from the head 3a, when vibration occurs, the moment of the joint 230_1 about the pivot axis O1 easily makes the amplitude of vibration of the head 3a larger than the amplitudes of the other joints 230, thereby having large effects on degradation in the image quality. Accordingly, degradation in the image quality may be suppressed by preventing the joint 230_1 from pivoting backward during the first print operation S10.

Furthermore, as described above, when the joint 230 for which the maximum value of the pivot speed is the largest during the first print operation S10 among the M number of joints 230 is the second joint, then the second joint does not pivot backward during the first print operation S10. As the pivot speed of the joint 230 increases, vibration easily increases and attenuation of the vibration generated in the joint 230 takes a longer time. Accordingly, degradation in the image quality may be suppressed by preventing the second joint from pivoting backward during the first print operation S10. It should be noted that the second joint is determined to be one of the joints 230_2, 230_3, and 230_5 depending on the disposition of the workpiece W with respect to the robot 2 or and the motion route of the robot 2 in the embodiment.

In the embodiment, none of the M number of joints 230 pivot backward during the first print operation S10 as described above. Therefore, degradation in the image quality may be suppressed.

In addition, M=N is met as described above. That is, the number of joints 230 that pivot during the print operation is N, and the N number of joints 230 do not pivot backward during the print operation. As described above, the motion range of the robot 2 can be expanded by pivoting all the N number of joints 230 during the first print operation S10. As described above, degradation in the image quality may be suppressed by preventing all the joints 230 from pivoting backward while expanding the motion range by operating all the joints 230.

As described above, the three-dimensional object printing device 1 further includes the energy emitting portion 3c that emits energy for curing the ink on the workpiece W. Then, the three-dimensional object printing device 1 executes the curing operation S20 after the first print operation S10. In the curing operation S20, the energy emitting portion 3c irradiates the ink on the workpiece W with energy, and the head 3a does not eject the ink onto the workpiece W. In addition, at least one joint 230 of the joints 230 that do not pivot backward during the first print operation S10 pivots backward during the curing operation S20.

Since the head 3a does not eject the ink onto the workpiece W in the curing operation S20, even if vibration occurs in the joint 230, effects on degradation in the image quality are small. Accordingly, the freedom of motion of the robot 2 can be improved by pivoting at least one joint 230 backward during the curing operation S20. For example, the motion range of the curing operation S20 can be larger than the motion range of the first print operation S10. As a result, the ink on the workpiece W may be irradiated with the energy from the energy emitting portion 3c.

In addition, as described above, the three-dimensional object printing device 1 executes the second print operation S40, which is an example of the print operation, after the first print operation S10. In the second print operation S40, the head 3a ejects the ink to the second region RP2 while the robot 2 causes the head 3a to relatively scan the workpiece W. Here, the second region RP2 is a region on the workpiece W that is adjacent to the first region RP1 in the direction intersecting the scanning direction DS. The scanning direction DS is the direction in which the robot 2 causes the head 3a to relatively scan the workpiece W during the first print operation S10. Then, the three-dimensional object printing device 1 executes the movement operation S30 between the first print operation S10 and the second print operation S40. In the movement operation S30, the head 3a does not eject the ink onto the workpiece W while the robot 2 relatively moves the head 3a with respect to the workpiece W in the direction intersecting the scanning direction DS.

In addition, at least one joint 230 of the M number of joints 230 pivots backward during the first print operation S10. Here, the movement operation S30 is a line feed operation between the first printing pass and the second printing pass. This line feed operation does not affect the print quality because the head 3a does not eject the ink onto the workpiece W. Accordingly, the movement operation S30 can be used as the line feed operation by pivoting at least one joint 230 backward during the movement operation S30. In addition, the freedom of motion of the robot 2 can be improved, thereby enabling printing in a broader area.

Here, as described above, the number of joints 230 that pivot during the second print operation S40 of the N number of joints 230 is M. In addition, at least one joint 230 of the M number of joints 230 does not pivot backward during the second print operation S40. The vibration of the head 3a during the second print operation S40 can be reduced compared with the structure in which all the M number of joints 230 pivot backward during the second print operation S40. As a result, the image quality can be improved.

In addition, as described above, the three-dimensional object printing device 1 has the control device 10 that controls the driving of the robot 2 for changing the position of the head 3a that ejects a liquid onto the three-dimensional workpiece W. When at least one joint 230 of the plurality of joints 230 pivots backward along the motion route of the robot 2 while the head 3a ejects the ink onto the workpiece W, the control device 10 reports information about the backward pivot to the user in advance. Therefore, it is possible to urge the user to take measures for preventing degradation in the image quality from occurring.

### 2. Modifications

The embodiments exemplified above can be variously modified. Specific modifications that can be applied to the embodiments described above will be exemplified below. It should be noted that two or more modifications arbitrarily selected from the following exemplification can be combined as appropriate as long as the modifications do not contradict each other.

### 2-1. Modification 1

Although the scanning range of the head 3a during the print operation is included in the region REa in the embodiment described above, the present disclosure is not limited to this example and, for example, the scanning range of the head 3a during the print operation may be included in the region REb. In addition, when the scanning range of the head 3a during the print operation is included in the region REa or the region REb, part of the workpiece W may be located outside the region REa or the region REb.

### 2-2. Modification 2

In addition, although the head 3a is moved in the Y2 direction in the region in the X2 direction with respect to the base portion 210 of the robot 2 during the print operation in the embodiment described above, the disclosure is not limited to this example. For example, the region in which the head moves during the print operation is not limited to the region in the X2 direction with respect to the base portion 210 of the robot 2 but may be, for example, the region in the X1 direction with respect to the base portion 210 of the robot 2 or the region in the Y1 or Y2 direction with respect to the base portion 210 of the robot 2. In addition, the scanning direction DS, which is the movement direction of the head 3a during the print operation, may be the Y1 direction, the X1 direction, or the X2 direction. Furthermore, the scanning direction DS may be a direction inclined with respect to the X-axis, Y-axis, or Z-axis or may be a direction along a curved line.

### 2-3. Modification 3

In addition, although an aspect in which none of the joints 230 pivot backward during the print operation is exemplified in the embodiment described above, the present disclosure is not limited to the aspect and the effect is obtained as long as at least one joint 230 of the joints 230 that pivot during the print operation does not pivot backward during the print operation.

### 2-4. Modification 4

Although an aspect in which all the joints 230 pivot during the print operation is exemplified in the embodiment described above, the present disclosure is not limited to the aspect and at least one joint 230 need only pivot during the print operation. Even in this case, the effect is obtained when at least one joint 230 of the joints 230 that pivot during the print operation does not pivot backward during the print operation.

### 2-5. Modification 5

Although the structure that includes a 6-axis vertical multi-axis robot is exemplified as the robot in the embodiment described above, the present disclosure is not limited to the structure. The robot need only change the position and the attitude of the head three-dimensionally relative to the workpiece. Accordingly, the robot may be, for example, a vertical multi-axis robot other than a vertical 6-axis robot or may be a horizontal multi-axis robot. In addition, the robot arm may have a telescopic mechanism or the like in addition to the joints including the rotating mechanisms. However, in terms of the balance between the print quality during print operation and the freedom of operation of the moving mechanism during non-print operation, the moving mechanism may have a multi-axis robot having 6 or more axes.

### 2-6. Modification 6

Although the structure in which screws or the like is used to fix the head to the front end of the robot arm is exemplified in the embodiment described above, the present disclosure is not limited to this structure. For example, the head may be fixed to the front end of the robot arm by grasping the head with a grasping mechanism such as a hand attached to the front end of the robot arm.

### 2-7. Modification 7

Although the robot that moves the head is exemplified in the embodiment described above, the present disclosure is not limited to this structure and may have the structure in which, for example, the position of the head is fixed, the robot moves the workpiece, and the position and the attitude of the workpiece relative to the head are three-dimensionally changed. In this case, the workpiece is gripped by, for example, a gripping mechanism such as a hand attached to the front end of the robot arm. In this case, the robot 2 includes the arm having one end that supports the workpiece and the base portion coupled to the other end of the arm. In addition, the N number of joints provided in the arm include the first joint as a joint 230 capable of pivoting the arm 220 with respect to the base portion. Moreover, the M number of joints that pivot during the print operation include this first joint, and the first joint does not pivot backward during the first print operation S10.

### 2-8. Modification 8

Although an aspect in which the workpiece W is fixedly installed is exemplified in the embodiment described above, the present disclosure is not limited to the aspect and, for example, a robot disposed separately from the robot 2 may grasp the workpiece W. That is, the three-dimensional object printing device may have a first robot that grasps the head 3a and a second robot that grasps the workpiece W. In this case, the second robot puts the workpiece W in a first attitude and, in this state, printing is performed in the first region on the workpiece W in which printing is enabled within the range in which the joint of the first robot does not pivot backward. After that, the second robot changes the attitude of the workpiece W from the first attitude to a second attitude and, in this state, printing is performed in the second region that differs from the first region on the workpiece W in which printing is enabled within the range in which the joint of the first robot does not pivot backward.

Here, printing is enabled in the first region on the workpiece W even if the joint of the first robot does not pivot backward when the workpiece W is in the first attitude, but printing is disabled unless the joint of the first robot pivots backward when the workpiece W is in the second attitude. On the other hand, printing is disable in the second region on the workpiece W unless the joint of the first robot pivoting backward when the workpiece W is in the first attitude, but printing is enabled even if the joint of the first robot does not pivot backward when the workpiece W is in the second attitude.

### 2-9. Modification 9

Although the structure in which printing is performed with one type of ink is exemplified in the embodiment described above, the present disclosure is not limited to this structure and the present disclosure is applicable to the structure in which printing is performed with two or more types of ink.

### 2-10. Modification 10

The use of the three-dimensional object printing device according to the present disclosure is not limited to printing. For example, the three-dimensional object printing device that ejects a solution of a coloring material is used as a manufacturing apparatus for forming color filters for liquid crystal display devices. In addition, the three-dimensional object printing device that ejects a solution of a conductive material is used as a manufacturing apparatus for forming wiring and electrodes of a wiring substrate. In addition, the three-dimensional object printing device can also be used as a jet dispenser that applies a liquid of an adhesive or the like to a workpiece.

What is claimed is:

1. A three-dimensional object printing device comprising:
a head that ejects a liquid onto a three-dimensional workpiece; and
a robot that changes a position of the head relative to the three-dimensional workpiece,
wherein the robot has N number of joints pivotable about a plurality of pivot axes that differ from each other, N being a natural number of two or more,
a first print operation in which the head ejects the liquid to a first region on the workpiece while the robot changes the position of the head relative to the workpiece is executed,
the number of joints that pivot during the first print operation among the N number of joints is M, M being not less than 1 and not more than N, and
at least one joint among the M number of joints does not pivot backward during the first print operation.

2. The three-dimensional object printing device according to claim 1,
wherein the robot includes an arm having one end that supports the head and a base portion coupled to the other end of the arm,
the N number of joints include a first joint as a joint through which the arm is pivotable with respect to the base portion,
the M number of joints include a first joint, and
the first joint does not pivot backward during the first print operation.

3. The three-dimensional object printing device according to claim 1,
wherein, when a joint for which a maximum value of a pivot speed is the largest during the first print operation among the M number of joints is a second joint, the second joint does not pivot backward during the first print operation.

4. The three-dimensional object printing device according to claim 1,
wherein none of the M number of joints pivot backward during the first print operation.

5. The three-dimensional object printing device according to claim 4,
wherein M being not less than 3.

6. The three-dimensional object printing device according to claim 4,
wherein M=N.

7. The three-dimensional object printing device according to claim 6,
wherein M=6.

8. The three-dimensional object printing device according to claim 1, further comprising:
an energy emitting portion that emits energy for curing the liquid on the workpiece,
wherein a curing operation in which the energy emitting portion irradiates the liquid on the workpiece with the energy and the head does not eject the liquid onto the workpiece is executed after the first print operation, and
at least one joint of joints that do not pivot backward during the first print operation pivots backward during the curing operation.

9. The three-dimensional object printing device according to claim 1,
wherein, when a scanning direction is a direction in which the robot causes the head to relatively scan the workpiece during the first print operation and a second region is a region on the workpiece adjacent to the first region in a direction intersecting the scanning direction, a second print operation in which the head ejects the liquid to the second region while the robot causes the head to relatively scan the workpiece is executed after the first print operation,
a second print operation in which the head ejects the liquid to a second region on the workpiece while the robot relatively scans the workpiece is executed after the first print operation, and
a movement operation in which the head does not eject the liquid onto the workpiece while the robot moves the head relative to the workpiece in a direction intersecting the scanning direction is executed between the first print operation and the second print operation, and
at least one joint among the M number of joints pivots backward during the movement operation.

10. The three-dimensional object printing device according to claim 9,
wherein the number of joints that pivot during the second print operation among the N number of joints is M, and at least one joint among the M number of joints does not pivot backward during the second print operation.

11. A three-dimensional object printing device comprising:
a head that ejects a liquid onto a three-dimensional workpiece; and
a robot that changes a position of the head relative to the three-dimensional workpiece,
wherein the robot has N number of joints pivotable about a plurality of pivot axes that differ from each other, N being a natural number of two or more,
a print operation in which the head ejects the liquid onto the workpiece while the robot changes the position of the head relative to the workpiece is executed,
the number of joints that pivot during the print operation is N, and
the N number of joints do not pivot backward during the print operation.

12. A control device that controls driving of a robot that changes a position of a head ejecting a liquid onto a three-dimensional workpiece,
wherein the robot includes a plurality of joints pivotable about a plurality of pivot axes that differ from each other, and
when at least one joint among the plurality of joints pivots backward along a motion route of the robot while the head ejects the liquid onto the workpiece, information about backward pivot is reported to a user in advance.
